(19) United States
(12) Patent Application Publication
(10) Pub. No.: US 2021/0223933 A1
(43) Pub. Date: Jul. 22, 2021

(54) TOUCH PANEL AND DISPLAY DEVICE

(71) Applicant: WUHAN CHINA STAR OPOELECTRONICS SEMICONDUCTOR DESLPAY TECHNOLOGY CO., LTD., Wuhan (CN)

(72) Inventor: Haiyang Shen, wUHAN (CN)

(21) Appl. No.: 16/310,939

(22) PCT Filed: Aug. 15, 2018
(86) PCT No.: PCT/CN2018/100545

§ 371 Date: Dec. 18, 2018

(30) Foreign Application Priority Data
Jun. 15, 2018 (CN) 201810621205.X

(51) Int. Cl. G06F 3/041

(52) U.S. Cl. CPC G06F 3/04164

(57) ABSTRACT

The present disclosure provides a touch panel and a display device. Touch layers are respectively disposed on two surfaces of a substrate. The touch layers are divided into a plurality of dividing regions by patterning dividing lines, and connecting terminals and the wirings are disposed on only one side of the substrate. Compared with the prior art in which the connecting terminals and the wirings are required to be disposed on three sides of the substrate, a side number of disposing the connecting terminals and the wirings is decreased. As such, a design without border(s) is implemented.

### BACKGROUND

### Field

The present disclosure relates to a technological field of liquid crystals displays, and more particularly to a touch panel and a display device.

### Background

With the development of technologies of touch screens and the increasing demands of consumers for the appearances of touch products and touch feelings, more and more vendors of the touch screens use advanced technologies to hope that black borders of the touch screens are narrower or borders are not required.

FIG. 1 illustrates a simplified conventional touch panel. In order to identify a touch, it is required to dispose connecting terminals and wirings in an end a where a flexible printed circuit (FPC) board is positioned and to disposed connecting terminals and wirings in two edge sides b and c.

That is, in the conventional touch screens, screen printing conductive metal wirings are served as media for transmitting electrical signals between touch electrodes and an external processor. In order to cover the signal wirings, wide and opaque borders are disposed on substrates of the touch screens to cover areas of the signal wirings. This design makes the borders of the touch screens narrower. In order to make the touch screens display more contents in a limited size, decreasing the areas of the borders where the signal wirings are located and producing display effect without the borders are key points of increasing competitiveness of the market.

### SUMMARY OF THE DISCLOSURE

The present disclosure provides a touch panel and a display device capable of areas of borders of the touch panel.

To solve the above-mentioned problem, technical schemes provided by the present disclosure are as follows.

The present disclosure provides a touch panel including a substrate and a flexible printed circuit board. The substrate includes a first surface, a second surface, and a plurality of first connecting terminals and a plurality of second connecting terminals which are located on a same side of the substrate. The first connecting terminals are disposed on a first region of the side in parallel, and the connecting terminals are disposed on a second region of the side in parallel. A first touch layer is disposed on the first surface, m first dividing wirings are formed by patterning the first touch layer, the m first dividing wirings do not cross with each other, and the first touch layer is divided into m+1 independent first touch regions. Each of the first touch regions is connected to one of the first connecting terminals. A second touch layer is disposed on the second surface, n second dividing wirings are formed by patterning the second touch layer, the n second dividing wirings do not cross with each other, and the second touch layer is divided into n+1 independent second touch regions. Each of the second touch regions is connected to one of the second connecting terminals. In a direction perpendicular to the substrate, projections of the first touch regions are interlaced with projections of the second touch regions. The first connecting terminals and the second connecting terminals are all electrically connected to the flexible printed circuit board.

The first dividing wirings are arc lines in accordance with one preferred embodiment of the present disclosure.

Curvature radii of at least two of the first dividing wirings are different in accordance with one preferred embodiment of the present disclosure.

Curvature radii of the m first dividing wirings are different in accordance with one preferred embodiment of the present disclosure.

The second dividing wirings are arc lines in accordance with one preferred embodiment of the present disclosure.

Curvature radii of at least two of the second dividing wirings are different in accordance with one preferred embodiment of the present disclosure.

Curvature radii of the m first dividing wirings are different in accordance with one preferred embodiment of the present disclosure.

The substrate is a substrate glass, and the first touch layer and the second touch layer are indium tin oxide films in accordance with one preferred embodiment of the present disclosure.

The present disclosure provides a touch panel including a substrate and a flexible printed circuit board. The substrate includes a first surface, a second surface, and a plurality of connecting terminals which are located on a same side of the substrate. A first touch layer is disposed on the first surface, m first dividing wirings are formed by patterning the first touch layer, the m first dividing wirings do not cross with each other, and the first touch layer is divided into m+1 independent first touch regions. Each of the first touch regions is connected to one of the connecting terminals. A second touch layer is disposed on the second surface, n second dividing wirings are formed by patterning the second touch layer, the n second dividing wirings do not cross with each other, and the second touch layer is divided into n+1 independent second touch regions. Each of the second touch regions is connected to one of the connecting terminals. In a direction perpendicular to the substrate, projections of the first touch regions are interlaced with projections of the second touch regions. The connecting terminals are all electrically connected to the flexible printed circuit board

The first dividing wirings are straight lines in accordance with one preferred embodiment of the present disclosure.

Angles formed between at least two of the first dividing wirings and the side on which the connecting terminals are located are different in accordance with one preferred embodiment of the present disclosure.

Angles formed between the m first dividing wirings and the side on which the connecting terminals are located are different in accordance with one preferred embodiment of the present disclosure.

The second dividing wirings are straight lines in accordance with one preferred embodiment of the present disclosure.

Angles formed between at least two of the second dividing wirings and the side on which the connecting terminals are located are different in accordance with one preferred embodiment of the present disclosure.

Angles formed between the n second dividing wirings and the side on which the connecting terminals are located are different in accordance with one preferred embodiment of the present disclosure.

The connecting terminals are formed by patterning flexible metal layers in accordance with one preferred embodiment of the present disclosure.

The substrate is a soda-lime-based substrate glass or a silicon-boron-based substrate glass in accordance with one preferred embodiment of the present disclosure.

The first touch layer and the second touch layer are transparent conductive layer formed by a magnetron sputtering manner in accordance with one preferred embodiment of the present disclosure.

The first dividing wirings and the second dividing wirings are formed by etching the transparent conductive layers in accordance with one preferred embodiment of the present disclosure.

The present disclosure provides a display device including a display panel, a main board, and the touch panel provided by the present disclosure. The display panel is stacked with the touch panel. The display panel outputs an image. The image is displayed via a transparent region of the touch panel. The touch panel is electrically connected to the main board via the flexible printed circuit board, so that touch signals received by the touch panel are transmitted to the main board.

Beneficial effect of the present disclosure is described as follows. The touch layers are respectively disposed on the two surfaces of the substrate, the touch layers are divided into the dividing regions by patterning the dividing lines, and the connecting terminals and the wirings are disposed on only one side of the substrate. Compared with the prior art in which the connecting terminals and the wirings are required to be disposed on three sides of the substrate, a side number of disposing the connecting terminals and the wirings is decreased. As such, a design without border(s) is implemented, and demands of consumers for the appearances of touch products and touch feelings can be meet.

### BRIEF DESCRIPTION OF THE DRAWINGS

To describe the technical solutions of the embodiments of the present disclosure more clearly, the following briefly introduces the accompanying drawings required for describing the embodiments. Apparently, the accompanying drawings in the following description show only some embodiments of the present disclosure, and those skilled in the art may still derive other drawings from these accompanying drawings without creative efforts.

FIG. 1 illustrates a conventional touch panel.

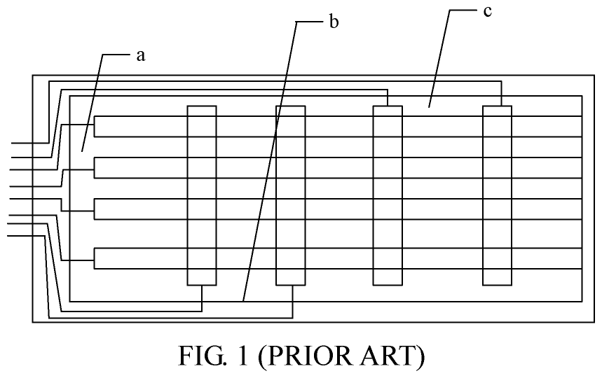

FIG. 2 illustrates a touch panel of the present disclosure.

FIG. 3 illustrates a first pattern on a first surface of the touch panel of the present disclosure.

FIG. 4 illustrates a second pattern on the first surface of the touch panel of the present disclosure.

FIG. 5 illustrates a first pattern on a second surface of the touch panel of the present disclosure

FIG. 6 illustrates a second pattern on a second surface of the touch panel of the present disclosure

FIG. 7 illustrates a flow chart of a method for manufacturing a touch panel in accordance of the present disclosure

### DETAILED DESCRIPTION OF THE PREFERRED EMBODIMENTS

The following embodiments are referring to the accompanying drawings for exemplifying specific implementable embodiments of the present disclosure. Furthermore, directional terms described by the present disclosure, such as upper, lower, front, back, left, right, inner, outer, side, etc., are only directions by referring to the accompanying drawings, and thus the used directional terms are used to describe and understand the present disclosure, but the present disclosure is not limited thereto. In the drawings, elements with similar structures are labeled with like reference numerals.

Embodiments of the present disclosure can solve the technical problem that connecting terminals and wirings are required to be disposed in a plurality of edge sides in the prior art.

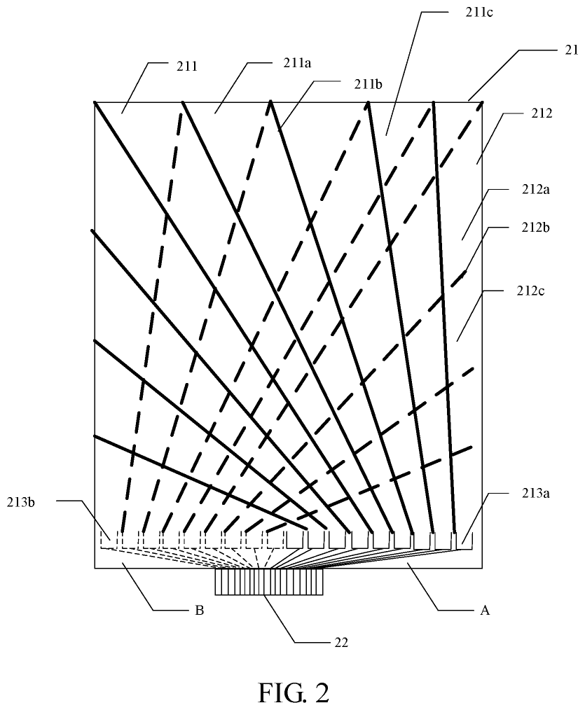

As shown in FIG. 2, a touch panel provided by the present disclosure includes a substrate 21 and a flexible printed circuit board 22.

The substrate 21 includes a first surface 211, a second surface 212, and a plurality of connecting terminals (including a plurality of connecting terminals 213a and a plurality of connecting terminals 213b) located on a same side of the substrate 21. Optionally, the substrate 21 is a transparent substrate.

A first touch layer 211a is disposed on the first surface 211, and m first dividing wirings 211b are formed by patterning the first touch layer 211a. The m first dividing wirings 211b do not cross with each other. The first touch layer 211a is divided into m+1 independent first touch regions 211c. Each of the first touch regions 211c is connected to one of the connecting terminals 213a.

A second touch layer 212a is disposed on the second surface 211, and n second dividing wirings 212b are formed by patterning the second touch layer 212a. The n second dividing wirings 212b do not cross with each other. The second touch layer 212a is divided into n+1 independent second touch regions 212c. Each of the second touch regions 212c is connected to one of the connecting terminals 213b. Dotted lines in FIG. 2 are perspective lines.

In a direction perpendicular to the substrate 21, projections of the first touch regions 211c are interlaced with projections of the second touch regions 212c.

The connecting terminals 213a and 213b are all electrically connected to the flexible printed circuit board 22.

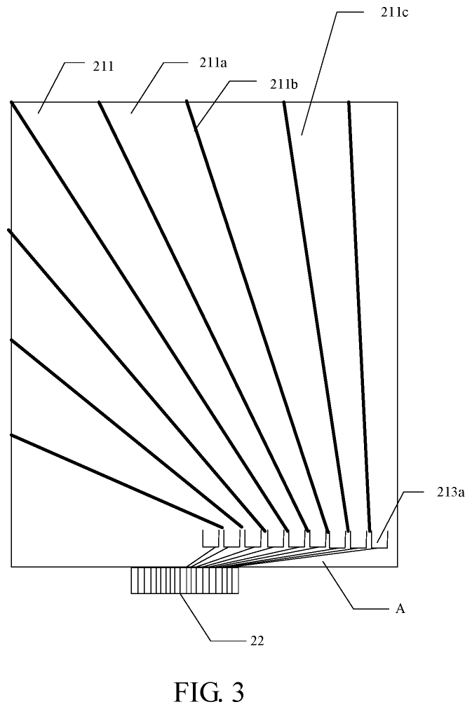

Optionally, as shown in FIG. 3, the first dividing wirings 211b are straight lines.

Optionally, as shown in FIG. 3, angles formed between at least two of the first dividing wirings 211b and the side on which the connecting terminals 213a are located are different.

Optionally, as shown in FIG. 3, angles formed between the m first dividing wirings 211b and the side on which the connecting terminals 213a are located are different.

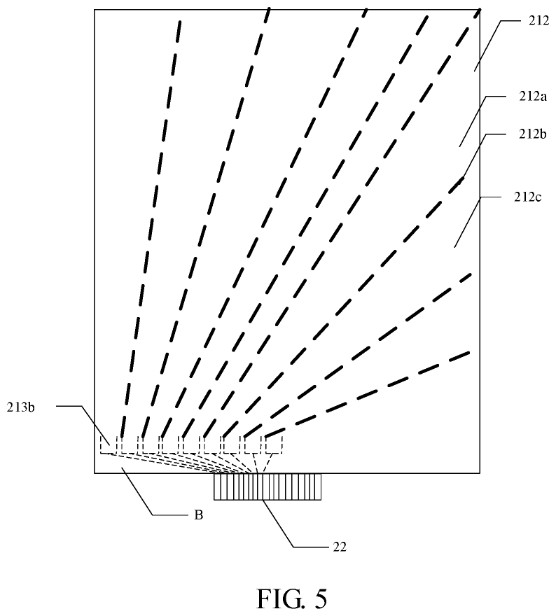

Optionally, as shown in FIG. 5, the second dividing wirings 212b are straight lines.

Optionally, as shown in FIG. 5, angles formed between at least two of the second dividing wirings 212b and the side on which the connecting terminals 213b are located are different.

Optionally, as shown in FIG. 5, angles formed between the n second dividing wirings 212b and the side on which the connecting terminals 213b are located are different.

Optionally, the connecting terminals 213a and 213b are formed by patterning flexible metal layers.

Optionally, the substrate 21 is a soda-lime-based substrate glass or a silicon-boron-based substrate glass.

Optionally, the first touch layer 211a and the second touch layer 212a are transparent conductive layer formed by a magnetron sputtering manner.

Optionally, the first dividing wirings 211b and the second dividing wirings 212b are formed by etching the transparent conductive layers.

As shown in FIG. 2, the touch panel provided by the present disclosure includes the substrate 21 and the flexible printed circuit board 22.

The substrate 21 includes the first surface 211, the second surface 212, and the plurality of first connecting terminals 213a and the plurality of second connecting terminals 213b located on the same side of the substrate 21. The first connecting terminals 213a are disposed on a first region A of the side in parallel. The second connecting terminals 213b are disposed on a second region B of the side in parallel.

The first touch layer 211a is disposed on the first surface 211, and the m first dividing wirings 211b are formed by patterning the first touch layer 211a. The m first dividing wirings 211b do not cross with each other. The first touch layer 211a is divided into the m+1 independent first touch regions 211c. Each of the first touch regions 211c is connected to one of the first connecting terminals 213a.

The second touch layer 212a is disposed on the second surface 211, and the n second dividing wirings 212b are formed by patterning the second touch layer 212a. The n second dividing wirings 212b do not cross with each other. The second touch layer 212a is divided into the n+1 independent second touch regions 212c. Each of the second touch regions 212c is connected to one of the second connecting terminals 213b.

In the direction perpendicular to the substrate 21, the projections of the first touch regions 211c are interlaced with the projections of the second touch regions 212c.

The first connecting terminals 213a and the second connecting terminals 213b are all electrically connected to the flexible printed circuit board 22.

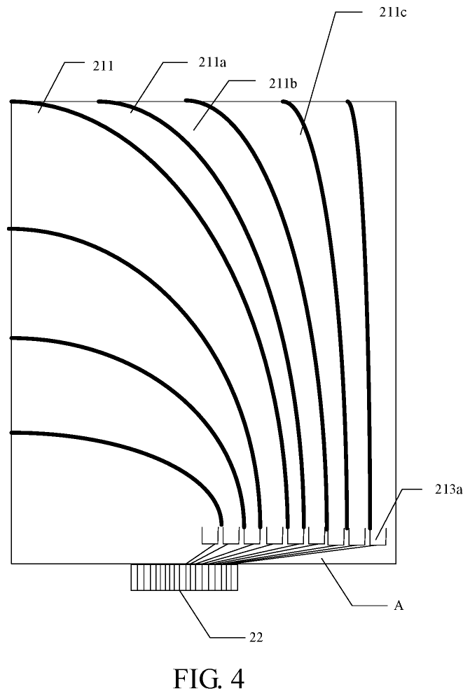

Optionally, as shown in FIG. 4, the first dividing wirings 211b are arc lines.

Optionally, as shown in FIG. 4, curvature radii of at least two of the first dividing wirings 211b are different.

Optionally, as shown in FIG. 4, curvature radii of the m first dividing wirings 211b are different.

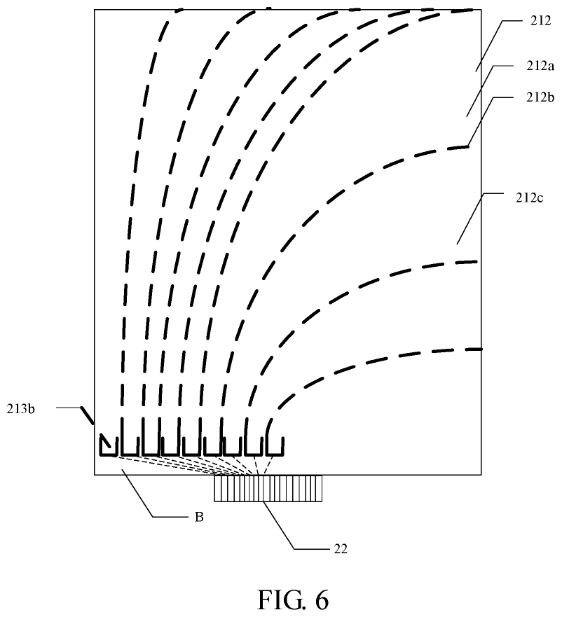

Optionally, as shown in FIG. 6, the second dividing wirings 212b are arc lines.

Optionally, as shown in FIG. 6, curvature radii of at least two of the second dividing wirings 212b are different.

Optionally, as shown in FIG. 6, curvature radii of the n second dividing wirings 212b are different.

Optionally, the substrate 21 is a substrate glass. The first touch layer 211a and the second touch layer 212a are indium tin oxide films.

Optionally, the connecting terminals 213a and 213b may be manufactured of a soft material to prevent cracks, e.g., a flexible metal (copper).

Meanwhile, the embodiments of the present disclosure further provides a display device including a display panel, a main board, and the touch panel provided by the present disclosure. The display panel is stacked with the touch panel. The display panel outputs an image, and the image is displayed via a transparent region of the touch panel. The touch panel is electrically connected to the main board via the flexible printed circuit board, so that touch signals received by the touch panel are transmitted to the main board.

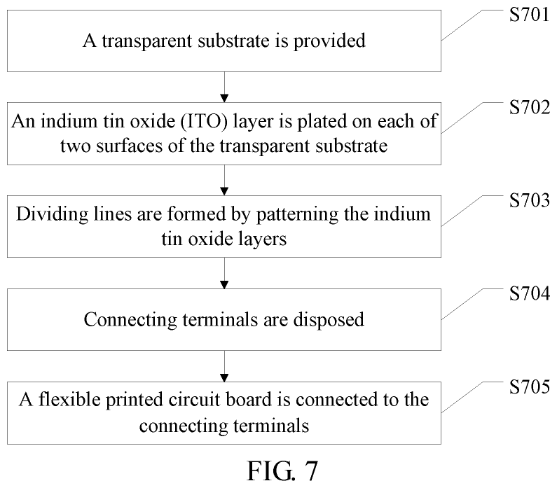

FIG. 7 illustrates a flow chart of a method for manufacturing a touch panel of the present disclosure. As shown in FIG. 7, the method for manufacturing the touch panel in accordance with the embodiment of the present disclosure includes the following steps.

In step S701, a transparent substrate is provided.

In the present disclosure, a process for manufacturing a conductive glass is selected to manufacture a touch panel.

In the present step, a transparent glass is provided to serve as a substrate.

In step S702, an indium tin oxide (ITO) layer is plated on each of two surfaces of the transparent substrate.

The indium tin oxide (ITO) layer is plated on each of the two surfaces of the transparent substrate by a sputtering evaporation method.

In step S703, dividing lines are formed by patterning the indium tin oxide layers.

The dividing lines are formed by patterning the indium tin oxide layers in a photolithography method. The dividing lines divide the indium tin oxide layers into a plurality of touch regions.

In step S704, connecting terminals are disposed.

A flexible metal is used to form the connecting terminals on a side of the substrate. Each of the connecting terminals is connected to one of the touch regions.

In step S705, a flexible printed circuit board is connected to the connecting terminals.

The flexible printed circuit board is electrically connected to the connecting terminals. The touch panel is produced by packaging the above-mentioned elements.

It can be understood from the above-mentioned embodiments that the touch layers are respectively disposed on the two surfaces of the substrate, the touch layers are divided into the dividing regions by patterning the dividing lines, and the connecting terminals and the wirings are disposed on only one side of the substrate. Compared with the prior art in which the connecting terminals and the wirings are required to be disposed on three sides of the substrate, a side number of disposing the connecting terminals and the wirings is decreased. As such, a design without border(s) is implemented, and demands of consumers for the appearances of touch products and touch feelings can be meet.

In summary, although the present disclosure has been provided in the preferred embodiments described above, the foregoing preferred embodiments are not intended to limit the present disclosure. Those skilled in the art, without departing from the spirit and scope of the present disclosure, may make modifications and variations, so the scope of the protection of the present disclosure is defined by the claims.

What is claimed is:

1. A touch panel, comprising a substrate and a flexible printed circuit board, wherein the substrate comprising a first surface, a second surface, and a plurality of first connecting terminals and a plurality of second connecting terminals which are located on a same side of the substrate;
the first connecting terminals are disposed on a first region of the side in parallel, and the connecting terminals are disposed on a second region of the side in parallel;
a first touch layer is disposed on the first surface, m first dividing wirings are formed by patterning the first touch layer, the m first dividing wirings do not cross with each other, and the first touch layer is divided into m+1 independent first touch regions;
each of the first touch regions is connected to one of the first connecting terminals;
a second touch layer is disposed on the second surface, n second dividing wirings are formed by patterning the second touch layer, the n second dividing wirings do not cross with each other, and the second touch layer is divided into n+1 independent second touch regions;
each of the second touch regions is connected to one of the second connecting terminals;
in a direction perpendicular to the substrate, projections of the first touch regions are interlaced with projections of the second touch regions;
the first connecting terminals and the second connecting terminals are all electrically connected to the flexible printed circuit board.

2. The touch panel of claim 1, wherein the first dividing wirings are arc lines.

3. The touch panel of claim 2, wherein curvature radii of at least two of the first dividing wirings are different.

4. The touch panel of claim 3, wherein curvature radii of the m first dividing wirings are different.

5. The touch panel of claim 1, wherein the second dividing wirings are arc lines.

6. The touch panel of claim 5, wherein curvature radii of at least two of the second dividing wirings are different.

7. The touch panel of claim 6, wherein curvature radii of the m first dividing wirings are different.

8. The touch panel of claim 1, wherein the substrate is a substrate glass, and the first touch layer and the second touch layer are indium tin oxide films.

9. A touch panel, comprising a substrate and a flexible printed circuit board, wherein the substrate comprising a first surface, a second surface, and a plurality of connecting terminals which are located on a same side of the substrate;
a first touch layer is disposed on the first surface, m first dividing wirings are formed by patterning the first touch layer, the m first dividing wirings do not cross with each other, and the first touch layer is divided into m+1 independent first touch regions;
each of the first touch regions is connected to one of the connecting terminals;
a second touch layer is disposed on the second surface, n second dividing wirings are formed by patterning the second touch layer, the n second dividing wirings do not cross with each other, and the second touch layer is divided into n+1 independent second touch regions;
each of the second touch regions is connected to one of the connecting terminals;
in a direction perpendicular to the substrate, projections of the first touch regions are interlaced with projections of the second touch regions;
the connecting terminals are all electrically connected to the flexible printed circuit board.

10. The touch panel of claim 9, wherein the first dividing wirings are straight lines.

11. The touch panel of claim 10, wherein angles formed between at least two of the first dividing wirings and the side on which the connecting terminals are located are different.

12. The touch panel of claim 11, wherein angles formed between the m first dividing wirings and the side on which the connecting terminals are located are different.

13. The touch panel of claim 9, wherein the second dividing wirings are straight lines.

14. The touch panel of claim 13, wherein angles formed between at least two of the second dividing wirings and the side on which the connecting terminals are located are different.

15. The touch panel of claim 14, wherein angles formed between the n second dividing wirings and the side on which the connecting terminals are located are different.

16. The touch panel of claim 9, wherein the connecting terminals are formed by patterning flexible metal layers.

17. The touch panel of claim 9, wherein the substrate is a soda-lime-based substrate glass or a silicon-boron-based substrate glass.

18. The touch panel of claim 9, wherein the first touch layer and the second touch layer are transparent conductive layer formed by a magnetron sputtering manner.

19. The touch panel of claim 18, wherein the first dividing wirings and the second dividing wirings are formed by etching the transparent conductive layers.

20. A display device, comprising a display panel, a main board, and the touch panel of claim 1, wherein the display panel is stacked with the touch panel, the display panel outputs an image, the image is displayed via a transparent region of the touch panel, the touch panel is electrically connected to the main board via the flexible printed circuit board, so that touch signals received by the touch panel are transmitted to the main board.
